(19) United States
(12) Patent Application Publication
(10) Pub. No.: US 2009/0004332 A1
(43) Pub. Date: Jan. 1, 2009

(54) Natural Salt Substitute

(75) Inventors: Yuval Katzir, Hefer (IL); Eli Budman, Moshav Bat Shlomo (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: GAN SHMUEL FOODS LTD., D.N. Hefer (IL)

(21) Appl. No.: 12/159,278

(22) PCT Filed: Dec. 10, 2007
(86) PCT No.: PCT/IL07/01522

§ 371 Date: Jul. 14, 2008

(30) Foreign Application Priority Data
Dec. 25, 2006 (IL) 180308

(51) Int. Cl. A23L 1/237; A23L 1/221; A23L 1/22

(52) U.S. Cl. 426/62; 426/649; 426/271; 426/599; 426/638

(57) ABSTRACT

A salt substitute for replacing a significant part of NaCl in the human diet is provided, as well as a method for producing it. The substitute, being manufactured from de-flavored discolored tomato serum contains only natural materials, and it may be a transparent liquid containing solids originating from tomatoes, further possibly having a reduced sugar content.

### FIELD OF THE INVENTION

The present invention relates to a natural salt substitute for use in food products, comprising a de-flavored discolored tomato serum. The substitute can replace a significant part of NaCl in the human diet without lowering the organoleptic quality of the food.

### BACKGROUND OF THE INVENTION

About one quarter of the US adult population suffer from hypertension. High blood pressure is associated with an increased risk of cardiovascular and other diseases, and its management requires a suitable medication combined with lifestyle modifications. The restriction of sodium intake plays an important role in the lifestyle changes. In some cases, dietary sodium restriction, accompanied by weight reduction, may even make drug therapy unnecessary [The Merck Manual 17^{th} Ed., 1999, page 1634]. The recommended daily limit of dietary sodium for the general public is about 2.5 grams, but American adults consume usually between 4 and 6 grams. Sodium chloride substitutes are, therefore, sought to replace at least partially the common salt, without negatively affecting the organoleptic properties of the food products.

The most straightforward seems to replace sodium chloride (NaCl) with potassium chloride (KCl), but KCl confers bitter taste, which must be reduced by adding further components. U.S. Pat. No. 5,626,904 and U.S. Pat. No. 6,541,050 describe purely inorganic mixtures, adding magnesium salts and sulfates, respectively, to KCl. U.S. Pat. No. 4,963,387 and EP 766927 admix to KCl components from whey, and magnesium salts with carboxylic acids, respectively. WO 05/086566 masks the KCl aftertaste with polyethylene glycol, while US 2006/24422 with an aspartame derivative.

Compositions for replacing the common salt, doing without KCl, have been described as well. U.S. Pat. No. 4,066,799 discloses glycine amide with glutamate, EP 813820 trehalose, and U.S. Pat. No. 6,013,298 sodium gluconate. WO 05/006881 proposes various chemicals as artificial agonists in affecting salt receptors in the mouth.

The drawbacks of the above materials include exposing the consumer to additives which comprise synthetic chemicals or artificial mixtures, which may lead to medical or regulatory problems. Some of the materials may be toxic in higher concentrations, some may induce allergy, and certain subjects show intolerance to some of the materials (e.g., trehalose). It is therefore an object of this invention to provide a salt substitute comprising natural materials.

It is another object of this invention to provide, for use in food products, a substitute for common salt which would be non-toxic and non-allergenic.

Other objects and advantages of present invention will appear as description proceeds.

### SUMMARY OF THE INVENTION

The present invention provides a natural common salt substitute for use in food products, comprising a de-flavored discolored tomato serum (DDTS). Said salt substitute consists essentially of a treated tomato serum, comprising soluble solids originating from tomatoes in a concentration of from 3.0 wt % to 80 wt %. In one embodiment, the substitute may be essentially a transparent liquid, for use in food products at a concentration of from 0.5 wt % to 6 wt %, based on the weights of said tomato solids and said food. The substitute of the invention is in a preferred embodiment a liquid containing from 3.5 wt % to 80 wt &, preferably from 55 wt % to 75 wt % solids originating from tomatoes. In another aspect of the invention, the substitute is a powder containing soluble solids originating from de-flavored discolored tomato serum. In one aspect of the invention, the salt substitute has a reduced content of lower sugars, relatively to the starting materials, achieved by a chemical, biochemical, or other treatment, for example by methods comprising fermentations, separations, or enzymatic or other reactions. A preferred method comprises fermenting with edible yeasts.

The invention relates to a method of manufacturing a common salt substitute, comprising i) selecting and washing sound tomatoes, crushing the washed tomatoes and heating them, for example at 50 to 90° C., screening the crushed tomatoes to remove particles greater than 1 mm, thereby removing peels and seeds from a crude juice, separating the pulp from the juice, thereby obtaining a low pulp juice; ii) clarifying the low pulp juice by fine filtration, thereby obtaining a clear tomato serum; iii) treating said clear serum with a sorbing material, such as resins, active charcoal, and others, thereby obtaining a serum without the typical tomato taste and color (de-flavored discolored tomato serum); and iv) optionally treating said de-flavored discolored tomato serum (DDTS) by passing it through an ion exchange column to de-acidify said DDTS; thereby obtaining a liquid common salt substitute. In a preferred embodiment of the invention, said method further comprises removing water from said DDTS or de-acidified DDTS, to achieve a solid concentration in the juice of up to 80 wt %. Said method according to the invention further comprises, in one embodiment, a step of pasteurizing the DDTS or de-acidified DDTS, for example at a temperature between 90 to 120° C. for about 20 to 40 seconds. Said concentration step may be performed, for example, at a temperature of between 40 and 70° C. under vacuum. In another aspect of the invention, an additional step of drying said liquid substitute is included, thereby obtaining a powdered natural common salt substitute. Said drying step may comprise lyophilization, spray drying, fluidized bed drying, or any other suitable type of drying.

In a preferred embodiment of the invention, the method of manufacturing the salt substitute further comprises a step of reducing the sugar content, for example by treating with edible yeasts. The sugar reduction may follow any one of said steps i) to iv), namely the step of separating the pulp from the juice, the step of clarifying the juice, the step of treating with a sorbent, and the step of deacidification. Said step of reducing the lower sugar content may comprise treating a tomato juice or serum with any nutritionally acceptable forms of enzymes.

It was found, and it is a part of the invention, that certain additives improve the olfactory and organoleptic properties of the substitute, acting as enhancers or synergists; yeast extracts are useful additives. In one embodiment, a method according to the invention also comprises a step of introducing yeast extract to an intermediate in the production of the salt substitute, or to the final product. Yeast extract may be added to the crude juice after the step of separating the pulp from the juice, said extract may be added to the clear tomato serum, or to any other intermediate in the production of DDTS, either before or after concentrating step or drying.

The invention further aims at food products comprising DDTS. Provided by the invention are stock solutions comprising the above DDTS. The DDTS according to the invention may be a solution or suspension, or it may be a solid, e.g. in the form of a powder. The invention also provides food additives comprising the DDTS as described, together with other components, for example with an item selected from salt, fibers, spices, herbs, cell extract, etc. A preferred additive is yeast extract.

### BRIEF DESCRIPTION OF THE DRAWINGS

The above and other characteristics and advantages of the invention will be more readily apparent through the following examples, and with reference to the appended drawings, wherein:

FIG. 1. is a flow chart showing the steps in a process for manufacturing a salt substitute according to the invention.

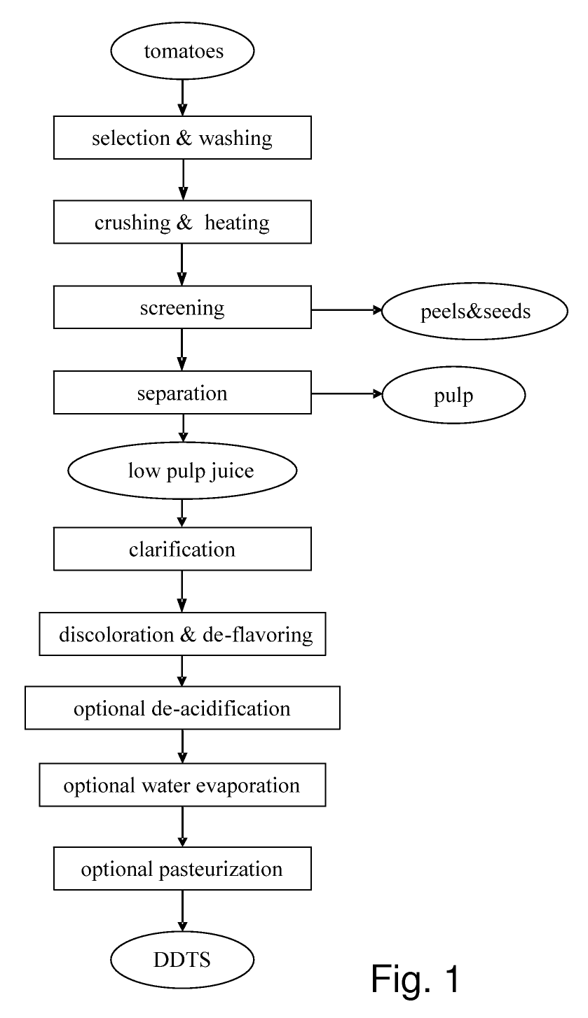

### DETAILED DESCRIPTION OF THE INVENTION

It has now been surprisingly found that a de-flavored discolored tomato serum (DDTS) can replace common salt in food products, enabling to replace a significant part of the salt amount in said products.

Furthermore, it has now been found that the organoleptic properties of the food products are not negatively affected by replacing a part of the salt with DDTS, as it is prepared by a novel process including ultra filtration of the tomato serum and treatment with an absorbent material and optionally ion exchange columns that remove residues of color, typical tomato taste and eventually acid taste. Thus a natural, low sodium, universal salt substitute is provided.

The fractionation of tomato juice employs known techniques applied in various order, including centrifugation, heat treatment, concentration, and extraction, providing pastes, suspensions, and solutions for use as sauce or juice or food additive. Processed fractions are often recombined to provide the final products, such as tomato concentrates. Usual problems include undesired taste or off-flavors, or aroma formed during the process. U.S. Pat. No. 5,229,160 provides fractions that separately keep the tomato aroma or flavor or color, comprising counter current extraction of heated tomato slices. WO 2005/074715 describes tomato concentrates that avoid the problems of unpleasant taste, and which further provide stable color, producing the concentrates by recombining the concentrated serum with the centrifugation sediment. U.S. Pat. No. 6,890,574 describes a method of enhancing the food flavor by adding a hydrolyzed tomato concentrate to the food, wherein the hydrolysis is achieved by prolonged heating of the concentrate or by added into it proteases. The concentrate must be added to the food only in a small quantity, about 0.5%, in order not to impart to the product a tomato flavor.

The invention relates to a process for manufacturing a tomato concentrate, which is a colorless solution, comprising from 300 g to 800 g solids per kg of solution. The process of the invention comprises steps of washing selected tomatoes, crushing and heating the tomatoes, screening on sieves to remove particles greater than about 1 mm, thereby obtaining a first (crude) juice, and fractionating the crude juice into 2 portions: thicker tomato flesh and low pulp tomato juice. The low pulp tomato juice is clarified by fine filtration, e.g. on a 500 kD filter, and the filtrate is treated with a sorbent and optionally loaded onto an ion exchange column to remove the color and undesirable flavors. The decolorized liquid is concentrated by water evaporation, until a concentration of the solids from 300 g to 800 g per kg solution is reached, thereby obtaining a low-sodium liquid salt substitute of natural origin. The shelf life of the said product is at least 6 months at a temperature lower than −18° C.

The invention provides a method of replacing common salt in the food product at least partially by a DDTS serum. The concentrated serum according to the invention may be added to a food product, in some embodiments, in a concentration of from 0.5 wt % to 5 wt % (weight DDTS solids per total food weight), substituting for about 0.5% NaCl. The DDTS provides desired salty taste, and, moreover, no tomato taste is imparted to the product even at concentrations up to 5 wt %.

The invention provides a common salt substitute that originates from natural products, and that can be used in any food product without imparting any unpleasant taste, or even without imparting the tomato taste, and without changing the color of the product. New universal means is, thus, provided to the food industry for lowering dietary sodium, without lowering organoleptic properties of the product. The new means, highly important for individuals suffering from hypertension, but also useful for consumers looking for a healthier lifestyle, is a desired product on the increasingly more demanding market of healthy products. The DDTS salt substitute, being a vegetable product, does not comprise any foreign chemicals, and is also suitable for vegetarians and vegans.

The invention will be further described and illustrated in the following examples.

### EXAMPLE

### Sensory Evaluation of the Salt Substitute in Clear Chicken Soup

The clear chicken soup was prepared by cooking 6 chicken drumsticks, without skin, total weight of 820 grams, in 8 liters of water for 10 min in order to wash off the excess of fat, followed by replacing the water with fresh one and cooking for 90 min, and finally followed by passing through a cloth filter. A salt substitute prepared according to the invention, in the form of a solution containing 60% of DDTS solids, was used in the experiment. Normally, a level of 0.8% common salt would be used for the soup, but for this experiment, a comparative sample with half the normal level was prepared, and a sample that contained the same reduced level of common salt together with the substitute of the invention (DDTS). Two samples for sensory evaluation were prepared as follows.

Sample I—Without salt substitute: 0.4 w/w % of fine table salt was added to the soup.

Sample II—With salt substitute: 0.4 w/w % of fine table salt plus 3 w/w % of DDTS.

A brown sugar color was added to both samples in order to mask an eventual difference in color. The samples were simmered to 60° C. just before the test. The test was performed by a market research and technology centre in Tel Aviv, Israel, including 60 subjects aged between 18 and 55, comprising 52% women and 48% men.

The following table shows the questions asked, and the percentage of the participants giving a positive answer (1^{st} question, can total more than 100%), or preferring one of the two products (2^{nd} and 3^{th} question, should total less than 100%).

| Question | Salt only | Salt + DDTS |
|---|---|---|
| Do you like the taste of the product? | 56 | 64 |
| Which product of the two do you prefer? | 27 | 63 |
| Which product of the two is more salty? | 42 | 51 |

It can be seen that the product comprising the substitute of the invention was evaluated as more tasty, preferred, and salty.

While this invention has been described in terms of some specific examples, many modifications and variations are possible. It is therefore understood that within the scope of the appended claims, the invention may be realized otherwise than as specifically described.

1. A natural common salt substitute for use in food products, comprising a de-flavored discolored tomato serum (DDTS).

2. A common salt substitute according to claim 1, consisting essentially of treated tomato serum, comprising solids originating from tomatoes in a concentration of from 3.0 wt % to 80 wt %.

3. A common salt substitute according to claim 1, being essentially a transparent liquid.

4. A common salt substitute according to claim 2, for use in food products at a concentration of from 0.5 to 6 wt %, wherein the wt % is based on the weight of said tomato solids and the weight of said food product.

5. A common salt substitute according to claim 1, being a liquid containing from 3.0 wt % to 80 wt % solids.

6. A common salt substitute according to claim 5, being a liquid containing from 55 wt % to 75 wt % solids.

7. A common salt substitute according to claim 1, wherein said DDTS has a reduced content of lower sugars.

8. A common salt substitute according to claim 7, wherein said reduced content is achieved by a treatment selected from fermentation, enzymatic reaction, and physical or chemical methods.

9. A common salt substitute according to claim 1, having a reduced content of lower sugars resulting from a fermentation by edible yeasts.

10. A common salt substitute, being a powder comprising solids originating from de-flavored discolored tomato serum.

11. A method of manufacturing a common salt substitute, comprising
i) selecting and washing sound tomatoes; crushing and heating the washed tomatoes; filtering the crushed tomatoes to remove particles greater than 1 mm, thereby removing peels and seeds from a crude juice; separating the pulp from the juice, thereby obtaining a low-pulp tomato juice;
ii) clarifying said low-pulp tomato juice by fine filtration, thereby obtaining a clear tomato serum;
iii) treating said clear serum with a sorbing material, thereby obtaining a serum without the typical tomato taste and color (de-flavored discolored tomato serum); and
iv) optionally treating said de-flavored discolored tomato serum (DDTS) by passing it through an ion exchange column, thereby obtaining de-acidified DDTS;
thereby obtaining a liquid common salt substitute.

12. A method according to claim 11, further comprising removing water by evaporation from said DDTS or said de-acidified DDTS, to achieve a solid concentration in the juice of up to 80 wt %.

13. A method of manufacturing a common salt substitute according to claim 11, further comprising drying step, thereby obtaining a powdered common salt substitute.

14. A method according to claim 13, wherein said drying step comprises a technique selected from lyophilization, spray drying, and fluidized bed drying.

15. A method according to claim 11, further comprising a step of treating with edible yeasts in order to reduce the amount of lower sugars, wherein said treating step may follow any one of said steps i) to iv).

16. A method according to claim 11, further comprising introducing yeast extract to said juice or to said powder.

17. A food product comprising a DDTS according to claim 1.

18. A stock solution comprising a DDTS according to claim 1.

19. A de-flavored discolored tomato serum according to claim 1, being a solution or suspension.

20. A de-flavored discolored tomato serum according to claim 1, being a powder.

21. A food additive comprising the DDTS of claim 1, and at least another additive selected from salt, fibers, spices, yeast extract, and herbs.
